(19) United States
(12) Patent Application Publication
(10) Pub. No.: US 2002/0025829 A1
(43) Pub. Date: Feb. 28, 2002

(54) Mobile communication terminal and information displaying method on the terminal and storing medium of programs of the method

(75) Inventor: Kenichi Kitatani, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/934,642

(22) Filed: Aug. 22, 2001

(30) Foreign Application Priority Data
Aug. 23, 2000 (JP) 258140/2000

(51) Int. Cl. H04M 1/00

(52) U.S. Cl. 455/550; 455/575

(57) ABSTRACT

A mobile communication terminal and an information displaying method on the terminal and a storing medium of programs of the method, in which the amount of information that can be displayed is increased without making the size of the terminal and the screen of the displaying section (LCD) in the terminal large, are provided. Each of plural input buttons of the mobile communication terminal emits light independently. And emitting light of each of the plural input buttons is controlled so that the combination of light emitted from plural buttons emitted light is made to be specified information by an instruction from each application.

### BACKGROUND OF THE INVENTION

The present invention relates to a mobile communication terminal and an information displaying method on the terminal and a storing medium of programs of the method, in particular, in which the amount of information that can be displayed is increased without making the size of the terminal large.

1. Description of the Related Art

Recently, in addition to the telephone calls, information communication has been spread at mobile communication terminals such as cellular phones and terminals of the personal handy-phone system (PHS). For example, the mobile communication terminals can send and receive e-mail messages, and also can connect to a short message service and Web sites on the Internet. Furthermore, data such as of music and pictures and images have been able to receive and send at the mobile communication terminals. Users operate these functions by pushing input buttons on the mobile communication terminal and recognize the information on a display and/or a speaker of the mobile communication terminal. At this time, the users use the input buttons as an inputting means, and use the display such as a liquid crystal display (LCD) and/or the speaker as an outputting means.

At the mobile communication terminal, the size of its displaying section has some limit because of its portability, compared with other information communication terminals such as a personal computer (PC). At the case that the mobile communication terminal desires to handle much more information, this physical limitation is a big problem. That is, even if the mobile communication terminal desires to display much more information, there occurs some limit in itself.

On the other hand, the users desire to handle much higher level information by easier operation. However, the number of the input devices of the mobile communication terminal must be kept in some suitable numbers. That is, many users are used to inputting figures by using a ten-key button part, and the ten-key button part can not be replaced by other devices.

At the conventional mobile communication terminal, the ten-key button part is almost used at the time when the user inputs figures. When the light of the ten-key button part is turned on, the light of all parts of the ten-key button part including a power button, an enter button (operation deciding button) and a back-light for the screen are turned on. And when the light of the ten-key button part is turned off, the light of all parts of the ten-key button is turned off. Therefore, there is a problem that the conventional mobile communication terminal has some limitation to display its input and output information.

### SUMMARY OF THE INVENTION

It is therefore an object of the present invention to provide a mobile communication terminal and an information displaying method on the terminal and a storing medium of programs of the method, in which the amount of information that can be displayed is increased without making the size of the terminal and the screen of the displaying section (LCD) in the terminal large.

According to a first aspect of the present invention for achieving the object mentioned above, there is provided a mobile communication terminal having plural input buttons, in which light of each of the plural input buttons is emitted and is turned off independently.

According to a second aspect of the present invention in the first aspect, a combination of the light emitted from each of the plural input buttons displays specified information.

According to a third aspect of the present invention in the second aspect, the specified information is a letter, an Arabic figure, a sign, or a pattern.

According to a fourth aspect of the present invention in the first aspect, each of the plural input buttons emits light by that each of the plural input buttons is pushed.

According to a fifth aspect of the present invention in the first aspect, it is instructed by each application that the light of each of the plural input buttons is emitted and is turned off independently.

According to a sixth aspect of the present invention in the first aspect, plural color light is emitted from each of the plural input buttons.

According to a seventh aspect of the present invention in the fifth aspect, plural color light is emitted from each of the plural input buttons by the instruction of each application.

According to an eighth aspect of the present invention, there is provided an information displaying method on a mobile communication terminal having plural input buttons in which light of each of the plural input buttons is emitted and is turned off independently. The information displaying method provides the steps of, instructing to make specified information display on the plural input buttons by each application, and displaying the specified information by a combination of light emitted from each of the plural input buttons.

According to a ninth aspect of the present invention in the eighth aspect, the specified information is a letter, an Arabic figure, a sign, or a pattern.

According to a tenth aspect of the present invention in the eighth aspect, plural color light is emitted from each of the plural input buttons.

According to an eleventh aspect of the present invention, there is provided a storing medium of programs of an information displaying method on a mobile communication terminal having plural input buttons in which light of each of the plural input buttons is emitted and is turned off independently. The storing medium of programs provides the steps of, instructing to make specified information display on the plural input buttons by each application, and displaying the specified information by a combination of light emitted from each of the plural input buttons.

According to a twelfth aspect of the present invention in the eleventh aspect, the specified information is a letter, an Arabic figure, a sign, or a pattern.

According to a thirteenth aspect of the present invention in the eleventh aspect, plural color light is emitted from each of the plural input buttons.

### BRIEF DESCRIPTION OF THE DRAWINGS

The objects and features of the present invention will become more apparent from the consideration of the following detailed description taken in conjunction with the accompanying drawings in which:

FIG. 1 is a plane view of an inputting section of a mobile communication terminal of the present invention;

FIG. 2 is a sectional view of the inputting section of the mobile communication terminal of the present invention;

FIG. 3 is a block diagram showing a conceptual structure of the mobile communication terminal at the embodiment of the present invention;

FIG. 4 is a diagram showing the short cut function at the embodiment of the mobile communication terminal of the present invention;

FIG. 5 is a diagram showing a figure game at the 12 button-part of the inputting section of the mobile communication terminal of the present invention;

FIG. 6 is a diagram showing a music game at the 12 button-part of the inputting section of the mobile communication terminal of the present invention;

FIG. 7 is a diagram showing the progress at the time when the user downloads information on the 12 button-part of the inputting section of the mobile communication terminal of the present invention;

FIG. 8 is a diagram showing the balance of electronic money at the 12 button-part of the inputting section of the mobile communication terminal of the present invention; and

FIG. 9 is a diagram showing an example that the 12 button-part of the inputting section of the mobile communication terminal of the present invention is used as a media controller.

### DESCRIPTION OF THE PREFERRED EMBODIMENTS

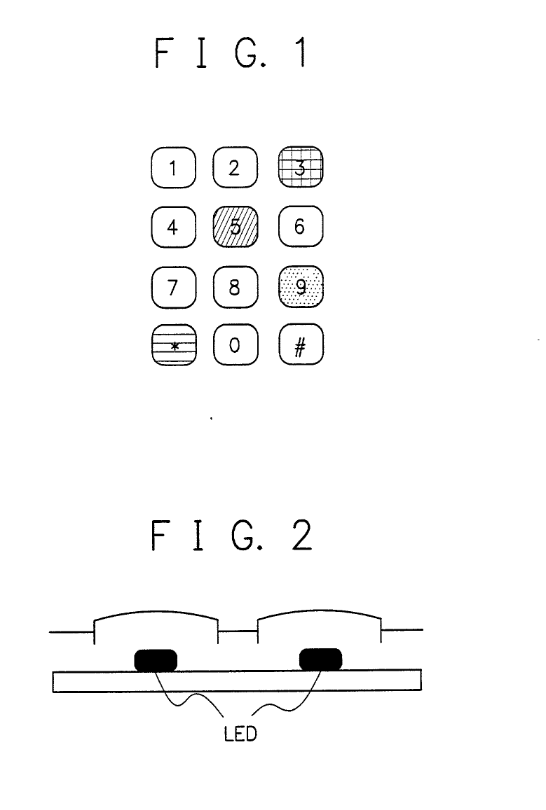

Referring now to the drawings, embodiments of the present invention are explained in detail. FIG. 1 is a plane view of an inputting section of a mobile communication terminal of the present invention. As shown in FIG. 1, the inputting section of the mobile communication terminal of the present invention consists of 12 buttons composed of 0 to 9 number keys, a * key, a # key. FIG. 2 is a sectional view of the inputting section of the mobile communication terminal of the present invention. As shown in FIG. 2, a light emitting device that emits a single color light or plural color light is disposed inside each of the 12 buttons. As a light emitting diode (LED) can be used as the light emitting device. Each button can emit the plural color light independently, and various kinds of patterns can be displayed on the inputting section by using the buttons. At the conventional inputting section, the light of each button cannot be turned on independently. Consequently, the conventional inputting section can only show a turning on the light state and a turning off the light state basically.

If each of the 12 buttons can turn on or off the light independently, 2¹²=4096 states can be displayed at the inputting section. Furthermore, if each button can be turned on the light by using the plural colors, much more states can be displayed at the inputting section. With this, the mobile communication terminal can display various input patterns and output patterns by using the buttons that have already been provided.

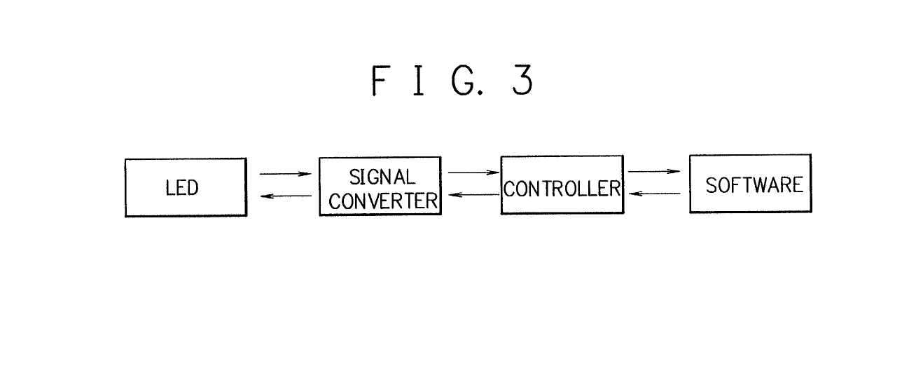

FIG. 3 is a block diagram showing a conceptual structure of the mobile communication terminal at the embodiment of the present invention. The displaying patterns on the 12 button-part are realized by that emitting light of each of the 12 buttons is controlled by software. At the case that some information is displayed on the 12 button-part at the inputting section instead of on the displaying screen (LCD), the application software for such as a game and browsing through Web sites instructs a controller so that the light of designated buttons is turned on for a designated time with a designated color. The controller outputs on/off control signals to LEDs. When on signals are inputted to the LEDs, electric energies are converted to light energies at the LEDs and the LEDs emit light.

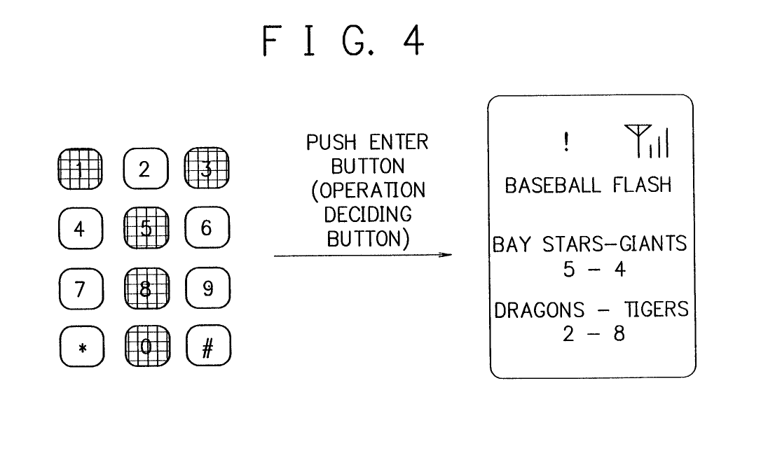

Next, referring to drawings, several examples at the embodiment of the mobile communication terminal of the present invention are explained. First, a short cut function at the embodiment of the mobile communication terminal of the present invention is explained. FIG. 4 is a diagram showing the short cut function at the embodiment of the mobile communication terminal of the present invention. A predetermined operation can be executed by inputting a displaying pattern of 12 buttons. At the case that a mobile communication terminal is in an idle mode and light turning off state, when a call is received or the user pushes a button, the light of all the 12 buttons is turned on with the same color.

At the light of all the button is in the turning on state, when a side button or a button, which is provided for an existing voice search function, is pushed for a long time, the light of all the buttons is turned off and a short cut menu inputting mode is realized.

At the short cut menu inputting mode, a user inputs a displaying pattern by pushing buttons. At this time, the light of the buttons pushed by the user is turned on. Therefore, the user can push the buttons while the user is confirming the displaying pattern that the user desires. The user pushes an enter button (operation deciding button) after inputting the displaying pattern. For example, at the case that a user is a baseball fan, as shown in FIG. 4, when the user inputs “Y ” pattern as the displaying pattern, the mobile communication terminal is set to connect to a Web site for baseball games, and the user can easily know the middle state of baseball games on the LCD.

At this short cut menu inputting mode, the user can arbitrary set his/her own displaying patterns. For example, displaying patterns for such as calling to a specified destination, sending an e-mail to a specified person, and accessing to a specified Web site on the Internet, which are not provided at the existing mobile communication terminal, can be set in the short cut menu.

Next, a lock canceling function is explained. Almost all the mobile communication terminals have a locking function in order not to be used by other persons without permission. Generally, a four digit number password is used to cancel this locked state, however, at the present invention, instead of this password, a displaying pattern used the 12 buttons is used.

The locked state is cancelled when a displaying pattern predetermined by a user beforehand is inputted. At the locked state, the user makes a displaying pattern for canceling the locked state by making the light of some of the 12 buttons turn on by pushing the buttons. After this, when the right displaying pattern made by the user is inputted, the locked state is canceled. Colors can be included in this displaying pattern. For example, at the case that three color LED is used at the button, the color is changed at each pushing, and the button is turned off after four pushing, and this displaying pattern can be made with some color by using this three color LED.

Next, a game function is explained. A user can enjoy playing games by making the light of some of the 12 buttons turn on and pushing the lighted buttons with the combination of the display on the LCD. The games are built in the mobile communication terminal, or are downloaded from the Internet sites on demand, or are played on the Internet sites. Several games are explained in detail.

First, an Arabic figure game is explained. Some Arabic figures are shown at certain positions on the screen of the LCD for a short while, and a player continues to push the buttons corresponding to the positions of the figures in order from the small figure.

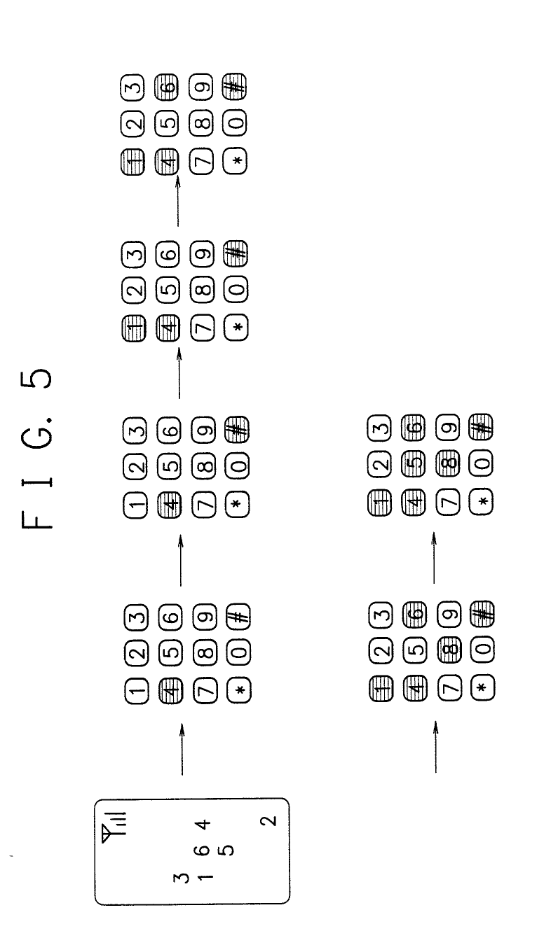

FIG. 5 is a diagram showing a figure game at the 12 button-part of the inputting section of the mobile communication terminal of the present invention. In FIG. 5, at the first time, only “1” is displayed, and at the second time, “1” and “2” are displayed, and at the third time, “1”, “2”, and “3” are displayed, and like this on the screen of the LCD, and the number of figures is increased corresponding to every time when the figures displayed on the screen are cleared. And the 12 figures are displayed at the largest. The displaying time can be made to be longer corresponding to that the number of figures is increased. And the player can also set the displaying time. When the player pushed a right button, a color showing the right answer is displayed on the right button, and when the answer was wrong, a displaying pattern showing the wrong answer is displayed, or a sound, music is reproduced to show the wrong answer.

Next, a music game is explained. Music is outputted from a speaker, and a light turning on pattern is moved from the upper row to the lower row in the horizontal direction in the 12 buttons corresponding to the music. When the light turning on pattern reaches the lowest row, the player pushes buttons whose light is turned on. The player pushes the buttons in the lowest row in the light turning on patterns moving from the upper row with the music.

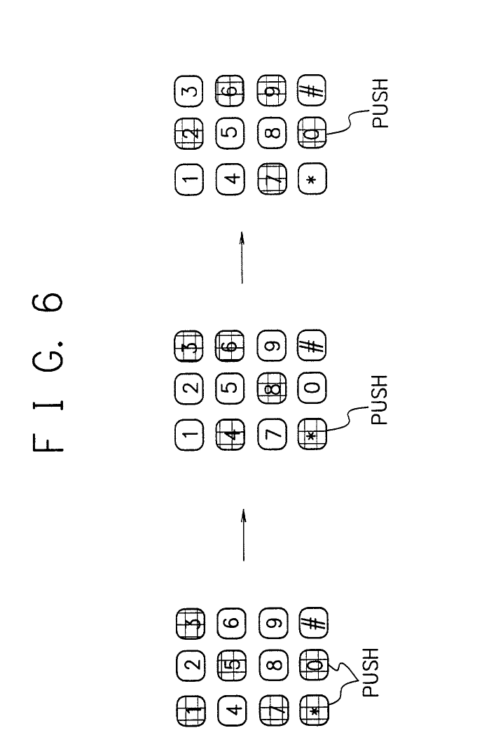

FIG. 6 is a diagram showing a music game at the 12 button-part of the inputting section of the mobile communication terminal of the present invention. As shown in FIG. 6, the player pushes buttons “*” and “0” at the first play, “*” at the second play, and “0” at the third play. And the player gains points by the accuracy of the positions and timing of the button pushing.

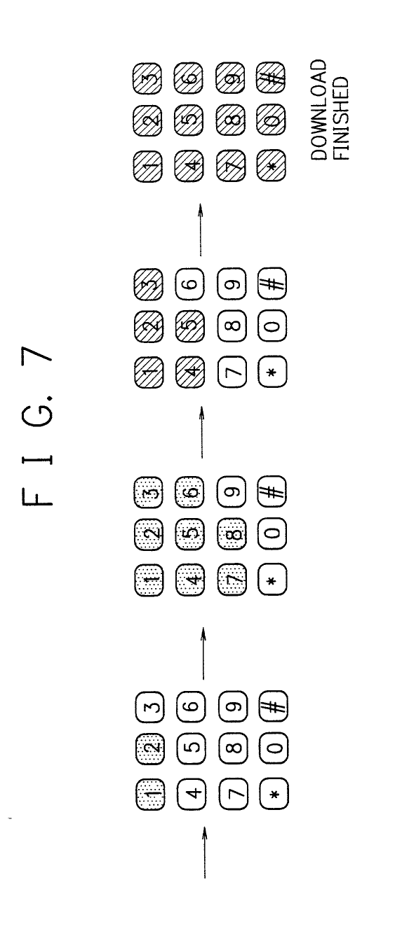

Next, displaying the progress at the time when a user downloads information is explained. FIG. 7 is a diagram showing the progress at the time when the user downloads information on the 12 button-part of the inputting section of the mobile communication terminal of the present invention. When a user downloads some music from a Web site on the Internet, the user cannot watch the progress of the download at the existing mobile communication terminal. However, at the present invention, the user can watch the progress of the downloading of the information by the display of the 12 buttons.

For example, at the case that a three-color LED is used at each button, the amount of the information to be loaded is divided into three equal parts, and one of the three colors is allocated to one of the three equal parts respectively. And the amount of the information in one of the three equal parts is again divided into 12 equal parts, and the light of the buttons is turned on corresponding to the amount of downloaded information. As shown in FIG. 7, first, two buttons of a color are turned on, and after that, eight buttons of the same color are turned on corresponding to the progress of the downloading information. And after passing the time, five buttons of a different color are turned on, and finally all the 12 buttons of the different color are turned on and the download of the information is finished.

Next, displaying a received call is explained. When a call is received, the light of the 12 buttons is turned on and off repeatedly with a ringing tone or a ringing melody. This repetition method can be set arbitrary. And each of displaying patterns of the 12 buttons can be allocated to each of persons who call the user. With this, the user can recognize the person without looking at the LCD.

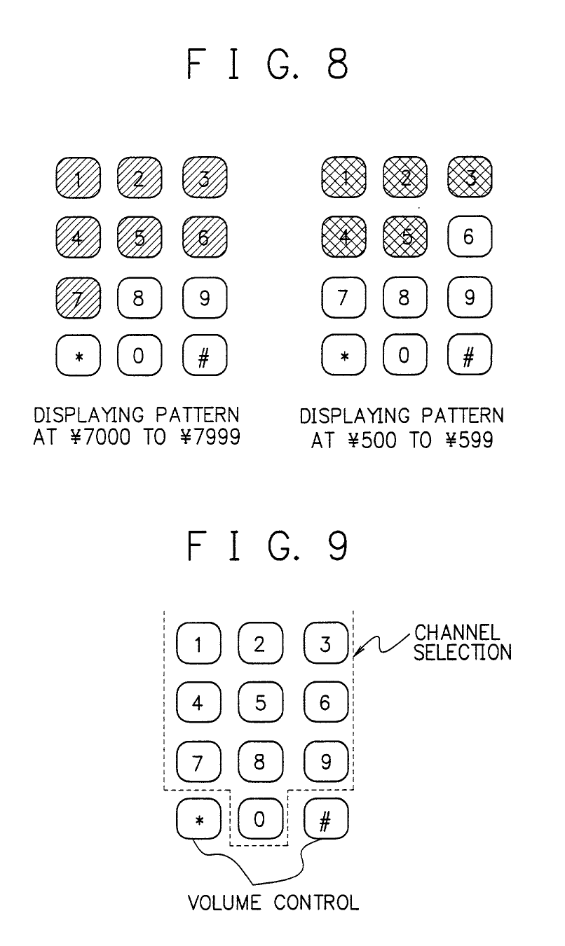

Next, displaying the balance of electronic money is explained. FIG. 8 is a diagram showing the balance of electronic money at the 12 button-part of the inputting section of the mobile communication terminal of the present invention. At the case that the payment can be electronically executed by using a mobile communication terminal, the user can recognize exactly or almost exactly the present balance at a glance by a displaying pattern of the 12 buttons. For example, there is a method that displays the figure in the maximum digit of the balance or a method that displays a color that signifies the digit of the balance. When the user receives money or deposits money and also the user pays money or transfer money, the user can recognize the change of the balance on the LCD and also the user can easily recognize the present balance by the display of the 12 buttons visibly.

As shown in FIG. 8, when the buttons 1 to 7 are turned on by a color, the balance is ¥ 7,000 to 7,999, and when the buttons 1 to 5 are turned on by a different color, the balance is ¥ 500 to 599.

Next, an application to a media controller for TV broadcasting and a music player is explained. FIG. 9 is a diagram showing an example that the 12 button-part of the inputting section of the mobile communication terminal of the present invention is used as a media controller. When a mobile communication terminal has a function to receive TV broadcasting, TV channels can be selected by using the ten-key buttons of the mobile communication terminal. And also the TV channel displaying at present can be shown by the ten-key buttons, for example, telling the digit of the channel number with colors. At this time, if a TV channel can be also selected by a scroll device on the mobile communication terminal, * button and # button are used for volume control, for example, the * button is used for turning down the volume and the # button is used for turning up the volume.

And when the mobile communication terminal has a function to reproduce music, arbitrary music can be reproduced by that the number of desiring music is designated by using a button of the 12 button-part. At this time, previous music and the next music can be also selected by scroll buttons, and * button and # button are used for volume control, for example, the * button is used for turning down the volume and the # button is used for turning up the volume.

And when the mobile communication terminal has a function to reproduce moving pictures, an arbitrary moving picture can be reproduced by that the number of a desiring moving picture is designated by using buttons of the 12 button-part. At this time, a previous moving picture and the next moving picture can be selected by a scroll device, (If the mobile communication terminal has it.) and * button and # button are used for volume control, for example, the * button is used for turning down the volume and the # button is used for turning up the volume.

At the embodiments of the present invention, the 12 button-part at the inputting section of the mobile communication terminal is used for displaying information. However, other buttons such as the power on button and the enter button (operation deciding button) can be used for displaying information. In this case, the amount of information, which can be displayed, can be further increased.

Moreover, the information displaying method of the present invention can be executed by computer programs. The computer programs are stored in a semiconductor storing medium and supplied to the mobile communication terminal, or are supplied to the mobile communication terminal through a network. Generally the file transfer protocol (FTP) is used, when the computer programs are supplied through the network.

As clearly mentioned above, according to the present invention, the amount of information, which a mobile communication terminal can display, can be increased. In other words, by using not only a displaying section (LCD) but also a button part for inputting information as a secondary displaying means, a maximum information displaying means can be realized in the physical limitation of the size of the mobile communication terminal.

And according to the present invention, patterns of buttons whose light is turned on are used for displaying information, therefore it is visually easy for a user to learn inputting processes, and also the user can enjoy looking output patterns. Furthermore, each button can be turned on with plural colors, therefore a colorful and nice looking mobile communication terminal can be realized.

Moreover, an information displaying region is only a screen at an existing mobile communication terminal, however at the present invention, an input button-part can also display information. That is, the input button-part, to which figures and letters are almost only inputted, has another function temporarily, and can be worked as a pattern inputting region, a selecting button, and a scroll button. And these functions are very effective for an operation for games that need to make the input and output operation work simultaneously.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A mobile communication terminal having plural input buttons, wherein:
light of each of said plural input buttons is emitted and is turned off independently.

2. A mobile communication terminal having plural input buttons in accordance with claim 1, wherein:
a combination of said light emitted from each of said plural input buttons displays specified information.

3. A mobile communication terminal having plural input buttons in accordance with claim 2, wherein:
said specified information is a letter, an Arabic figure, a sign, or a pattern.

4. A mobile communication terminal having plural input buttons in accordance with claim 1, wherein:
each of said plural input buttons emits light by that each of said plural input buttons is pushed.

5. A mobile communication terminal having plural input buttons in accordance with claim 1, wherein:
it is instructed by each application that said light of each of said plural input buttons is emitted and is turned off independently.

6. A mobile communication terminal having plural input buttons in accordance with claim 1, wherein:
plural color light is emitted from each of said plural input buttons.

7. A mobile communication terminal having plural input buttons in accordance with claim 5, wherein:
plural color light is emitted from each of said plural input buttons by said instruction of each application.

8. An information displaying method on a mobile communication terminal having plural input buttons in which light of each of said plural input buttons is emitted and is turned off independently, comprising the steps of:
instructing to make specified information display on said plural input buttons by each application; and
displaying said specified information by a combination of light emitted from each of said plural input buttons.

9. An information displaying method in accordance with claim 8, wherein:
said specified information is a letter, an Arabic figure, a sign, or a pattern.

10. An information displaying method in accordance with claim 8, wherein:
plural color light is emitted from each of said plural input buttons.

11. A storing medium of programs of an information displaying method on a mobile communication terminal having plural input buttons in which light of each of said plural input buttons is emitted and is turned off independently, comprising the steps of:
instructing to make specified information display on said plural input buttons by each application; and
displaying said specified information by a combination of light emitted from each of said plural input buttons.

12. A storing medium of programs of an information displaying method at a mobile communication terminal in accordance with claim 11, wherein:
said specified information is a letter, an Arabic figure, a sign, or a pattern.

13. A storing medium of programs of an information displaying method at a mobile communication terminal in accordance with claim 11, wherein:
plural color light is emitted from each of said plural input buttons.
